(19) United States
(12) Patent Application Publication
(10) Pub. No.: US 2025/0346457 A1
(43) Pub. Date: Nov. 13, 2025

(54) ELEVATOR SYSTEM AND COUNTERWEIGHT THEREFOR

(71) Applicant: Otis Elevator Company, Farmington, CT (US)

(72) Inventors: Bichun Li, Shanghai (CN); Hui Cui, Shanghai (CN); Wei Yao, Shanghai (CN); Yang Li, Shanghai (CN); Zhangming Xu, Shanghai (CN)

(21) Appl. No.: 19/196,165

(22) Filed: May 1, 2025

(30) Foreign Application Priority Data
May 9, 2024 (CN) 202410568109.9

(51) Int. Cl. B66B 17/12

(52) U.S. Cl. CPC B66B 17/12

(57) ABSTRACT

A counterweight for an elevator system and an elevator system. The elevator system includes an elevator car and a counterweight connected to each other through a rope; the counterweight includes a counterweight frame and a plurality of counterweight blocks mounted on the counterweight frame, the counterweight frame includes a first main surface and a second main surface opposite to each other, the counterweight blocks are arranged between the first main surface and the second main surface; a first inverted arch beam and a second inverted arch beam connected to the first main surface and the second main surface respectively; and a load-bearing shaft connected between the first inverted arch beam and the second inverted arch beam; the counterweight is connected to the rope through the load-bearing shaft.

### FOREIGN PRIORITY

This application claims priority to Chinese Patent Application No. 202410568109.9, filed May 9, 2024, and all the benefits accruing therefrom under 35 U.S.C. § 119, the contents of which in its entirety are herein incorporated by reference.

### TECHNICAL FIELD OF INVENTION

The present invention relates to the technical field of elevators, in particular to a counterweight for an elevator system and an elevator system.

### BACKGROUND OF THE INVENTION

An elevator system generally comprises an elevator car and a counterweight connected by a traction machine and a rope. A counterweight comprises a counterweight frame and a counterweight block. The suspension mechanism connected to the rope is usually designed at the top beam of the counterweight frame. In order to prevent bending deformation of the counterweight frame, the width of the counterweight frame is limited, and a certain height is required to place the counterweight block that balances the elevator car system and the passenger load. Therefore, the counterweight frame is generally designed to be narrow and high, which cannot effectively utilize the width space of the elevator shaft.

### SUMMARY OF THE INVENTION

The objective of the present invention is to solve or at least alleviate the problems existing in the prior art.

According to one aspect of the present invention, an elevator system is provided, comprising: an elevator car and a counterweight connected to each other through a rope; wherein, the counterweight comprises a counterweight frame and a plurality of counterweight blocks mounted on the counterweight frame, the counterweight frame comprising: a first main surface and a second main surface opposite to each other, wherein the counterweight blocks are arranged between the first main surface and the second main surface; a first inverted arch beam and a second inverted arch beam connected to the first main surface and the second main surface respectively; and a load-bearing shaft connected between the first inverted arch beam and the second inverted arch beam; wherein, the counterweight is connected to the rope through the load-bearing shaft.

Optionally, in an embodiment of the elevator system, a pulley or rope connector is provided on the load-bearing shaft.

Optionally, in an embodiment of the elevator system, the first inverted arch beam and the second inverted arch beam are in the shape of an inverted curved arch, an inverted obtuse angle arrow, or an inverted trapezoid.

Optionally, in an embodiment of the elevator system, the counterweight frame comprises: a bottom beam, a top beam, a first longitudinal beam, and a second longitudinal beam, wherein the bottom beam, top beam, first longitudinal beam, and second longitudinal beam are connected to form an outer contour of a rectangular frame; and a first intermediate longitudinal beam and a second intermediate longitudinal beam connected between the bottom beam and the top beam; wherein, the first inverted arch beam and the second inverted arch beam span and connect to the first longitudinal beam, the first intermediate longitudinal beam, the second intermediate longitudinal beam, and the second longitudinal beam.

Optionally, in an embodiment of the elevator system, a first counterweight block groove is defined between the first longitudinal beam and the first intermediate longitudinal beam, and a first set of counterweight blocks are stacked in the first counterweight block groove longitudinally; a second counterweight block groove is defined between the second longitudinal beam and the second intermediate longitudinal beam, and a second set of counterweight blocks are stacked in the second counterweight block groove longitudinally; and a third counterweight block groove is defined between the first intermediate longitudinal beam and the second intermediate longitudinal beam, and a third set of counterweight blocks are stacked in the third counterweight block groove longitudinally.

Optionally, in an embodiment of the elevator system, the position of the top beam corresponding to the first counterweight block groove has a first top opening and a first top cover mounted on the first top opening; and the position of the top beam corresponding to the second counterweight block groove has a second top opening and a second top cover mounted on the second top opening.

Optionally, in an embodiment of the elevator system, the first inverted arch beam and the second inverted arch beam are arranged in the upper one-third area of the counterweight frame.

Optionally, in an embodiment of the elevator system, the first inverted arch beam and the second inverted arch beam are arranged in the lower two-thirds area of the counterweight frame, and a first additional crossbeam and a second additional crossbeam are respectively arranged above the first inverted arch beam and the second inverted arch beam.

Optionally, in an embodiment of the elevator system, the first inverted arch beam is integrally formed with the first additional crossbeam, and the second inverted arch beam is integrally formed with the second additional crossbeam.

Optionally, in an embodiment of the elevator system, the counterweight frame is bilaterally symmetrical on the first main surface and the second main surface.

Optionally, in an embodiment of the elevator system, the central area of the first inverted arch beam and the second inverted arch beam is widened.

Optionally, in an embodiment of the elevator system, each of the plurality of counterweight blocks is less than 25 kilograms.

According to another aspect of the present invention, a counterweight for an elevator system is provided, comprising: a counterweight frame and a plurality of counterweight blocks mounted on the counterweight frame, the counterweight frame comprising: a first main surface and a second main surface opposite to each other, wherein the counterweight blocks are arranged between the first main surface and the second main surface; a first inverted arch beam and a second inverted arch beam connected to the first main surface and the second main surface respectively; and a load-bearing shaft connected between the first inverted arch beam and the second inverted arch beam.

Optionally, in an embodiment of the counterweight, a pulley or rope connector is provided on the load-bearing shaft.

Optionally, in an embodiment of the counterweight, the first inverted arch beam and the second inverted arch beam are in the shape of an inverted curved arch, an inverted obtuse angle arrow, or an inverted trapezoid.

Optionally, in an embodiment of the counterweight, the counterweight frame comprises: a bottom beam, a top beam, a first longitudinal beam, and a second longitudinal beam, wherein the bottom beam, top beam, first longitudinal beam, and second longitudinal beam are connected to form an outer contour of a rectangular frame; and a first intermediate longitudinal beam and a second intermediate longitudinal beam connected between the bottom beam and the top beam; wherein, the first inverted arch beam and the second inverted arch beam span and connect the first longitudinal beam, the first intermediate longitudinal beam, the second intermediate longitudinal beam, and the second longitudinal beam.

Optionally, in an embodiment of the counterweight, a first counterweight block groove is defined between the first longitudinal beam and the first intermediate longitudinal beam, and a first set of counterweight blocks are stacked in the first counterweight block groove longitudinally; a second counterweight block groove is defined between the second longitudinal beam and the second intermediate longitudinal beam, and a second set of counterweight blocks are stacked in the second counterweight block groove longitudinally; and a third counterweight block groove is defined between the first intermediate longitudinal beam and the second intermediate longitudinal beam, and a third set of counterweight blocks are stacked in the third counterweight block groove longitudinally.

Optionally, in an embodiment of the counterweight, the position of the top beam corresponding to the first counterweight block groove has a first top opening and a first top cover mounted on the first top opening; and the position of the top beam corresponding to the second counterweight block groove has a second top opening and a second top cover mounted on the second top opening.

Optionally, in an embodiment of the counterweight, the first inverted arch beam and the second inverted arch beam are arranged in the upper one-third area of the counterweight frame.

Optionally, in an embodiment of the counterweight, the first inverted arch beam and the second inverted arch beam are arranged in the lower two-thirds area of the counterweight frame, and a first additional crossbeam and a second additional crossbeam are respectively arranged above the first inverted arch beam and the second inverted arch beam.

Optionally, in an embodiment of the counterweight, the first inverted arch beam is integrally formed with the first additional crossbeam, and the second inverted arch beam is integrally formed with the second additional crossbeam.

Optionally, in an embodiment of the counterweight, the counterweight frame is bilaterally symmetrical on the first main surface and the second main surface.

Optionally, in an embodiment of the counterweight, the central area of the first inverted arch beam and the second inverted arch beam is widened.

Optionally, in an embodiment of the counterweight, each of the plurality of counterweight blocks is less than 25 kilograms.

The counterweight frame according to the embodiments of the present invention may have a larger width and be less prone to bending deformation.

### BRIEF DESCRIPTION OF THE DRAWINGS

With reference to the accompanying drawings, the disclosure of the present invention will become easier to understand. Those skilled in the art would easily understand that these drawings are for the purpose of illustration, and are not intended to limit the protection scope of the present invention. In addition, in the figures, similar numerals are used to denote similar components, where:

FIG. 1 is a schematic diagram of an exemplary elevator system;

FIGS. 2 and 3 are perspective views of a counterweight frame according to one embodiment;

FIG. 4 is a front view of a counterweight according to one embodiment;

FIG. 5 is a perspective view of a counterweight frame according to another embodiment; and

FIGS. 6 and 7 are front views of a counterweight frame according to other embodiments.

### DETAILED DESCRIPTION OF THE INVENTION

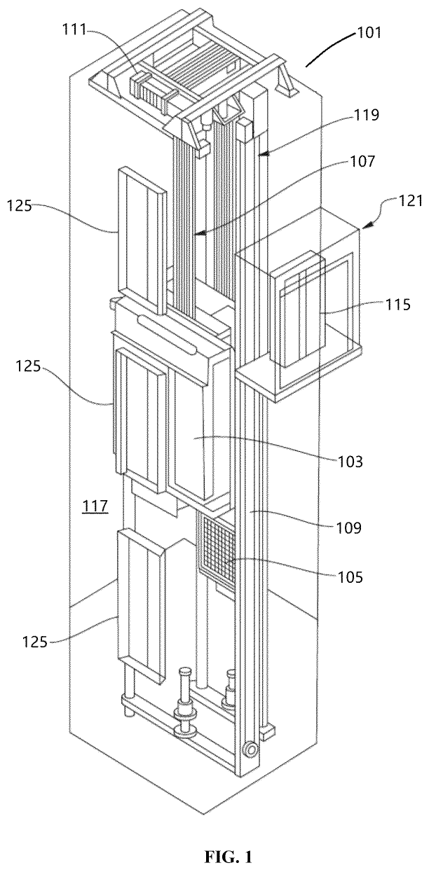

FIG. 1 is a perspective view of an elevator system 101 including an elevator car 103, a counterweight 105, a rope 107, a guide rail 109, a traction machine 111, and an elevator system controller 115. The elevator car 103 and counterweight 105 are connected to each other by the rope 107. The rope 107 may include or be configured as, for example, ropes, steel cables, and/or coated-steel belts. In this embodiment, the rope is configured as a rope strip integrated with a plurality of ropes. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109. The rope 107 engages the traction machine 111, which is part of an overhead structure of the elevator system 101. The traction machine 111 is configured to control movement between the elevator car 103 and the counterweight 105.

The elevator system controller 115 is located, as shown, in an elevator system controller room 121 of the elevator shaft 117 and is configured to control the operation of the elevator system 101, and particularly the elevator car 103. For example, the elevator system controller 115 may provide drive signals to the traction machine 111 to control the acceleration, deceleration, leveling, stopping, etc. of the elevator car 103. When moving up or down within the elevator shaft 117 along guide rail 109, the elevator car 103 may stop at one or more landings 125 as controlled by the elevator system controller 115. Although shown in an elevator system controller room 121, those of skill in the art will appreciate that the elevator system controller 115 can be located and/or configured in other locations or positions within the elevator system 101. The traction machine 111 may include a motor or similar driving mechanism.

Although shown and described with a roping system, elevator systems that employ other methods and mechanisms of moving an elevator car within an elevator shaft may employ embodiments of the present invention. FIG. 1 is merely a non-limiting example presented for illustrative and explanatory purposes.

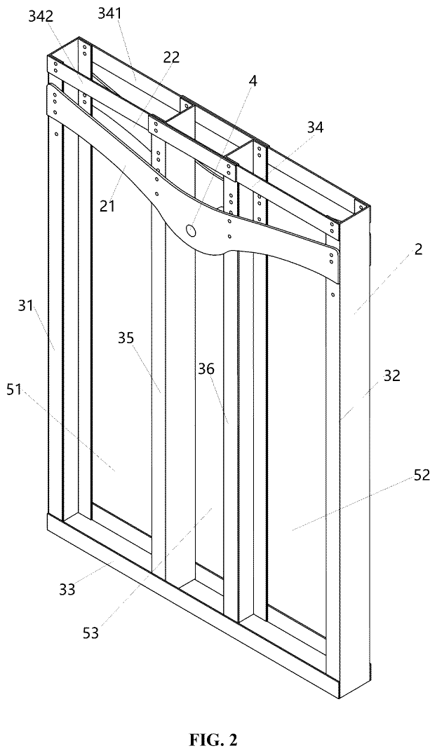

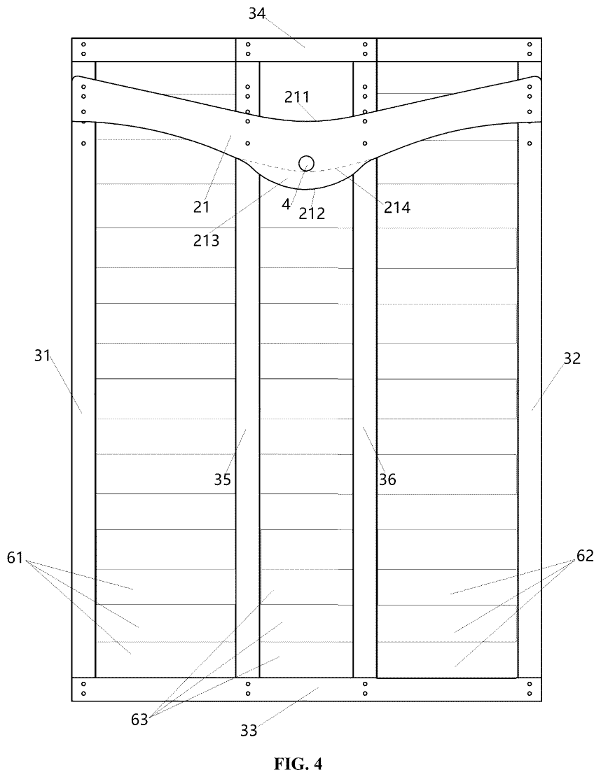

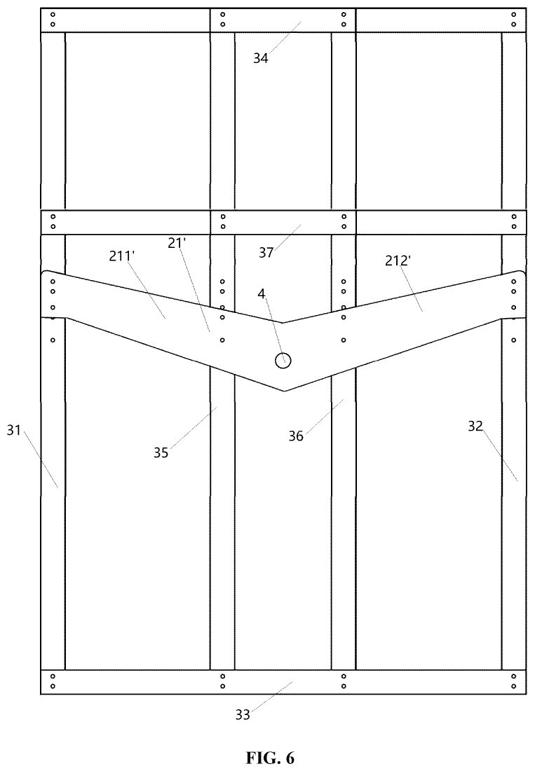

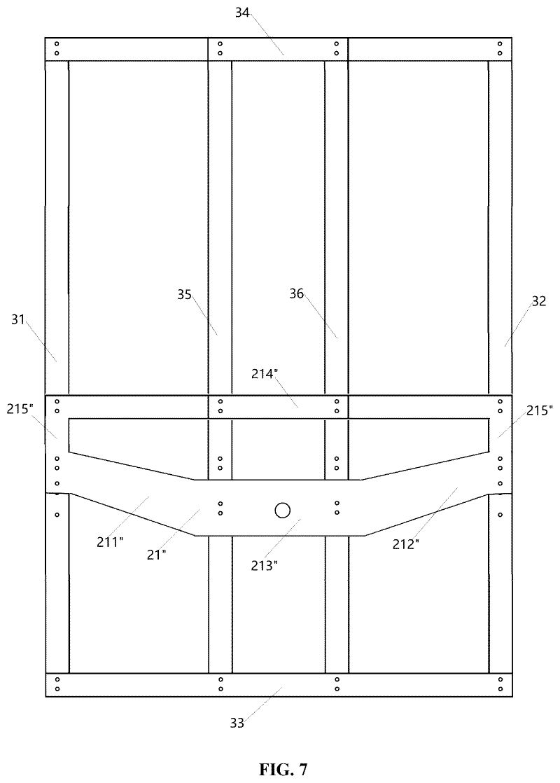

The exemplary elevator system shown in FIG. 1 includes an elevator car 103 and a counterweight 105 connected to each other by a rope 107. The counterweight frame and counterweight according to one embodiment of the present invention are described by referring to FIGS. 2 to 4. For the counterweight 105, it generally comprises a counterweight frame 2 and a plurality of counterweight blocks 61, 62, 63 mounted on the counterweight frame 2. The counterweight frame comprises: a first main surface and a second main surface opposite to each other, with the counterweight blocks arranged between the first main surface and the second main surface; a first inverted arch beam 21 and a second inverted arch beam 22 respectively connected to the first main surface and the second main surface; and a load-bearing shaft 4 connected between the first inverted arch beam 21 and the second inverted arch beam 22; wherein, the counterweight is connected to the rope 107 through the load-bearing shaft 4. The counterweight generally has a flat shape, and the first main surface and second main surface herein refer to a pair of surfaces with the largest surface area. For the counterweight frame 2, which is generally in the form of a cube, the first and second main surfaces refer to the front and rear sides of the counterweight frame 2 in the figure. “Inverted arch beam” herein refers to any shape with curvature and/or slope that makes the beam less prone to deformation compared to a straight shape. As shown in FIG. 4, in this embodiment, the first inverted arch beam 21 and the second inverted arch beam 22 form an inverted curved arch. In alternative embodiments, the first inverted arch beam 21 and the second inverted arch beam 22 can be constructed in any other suitable shape, such as the shapes shown in FIGS. 6 and 7. The use of a pair of downward protruding beams 21 and 22 as the load-bearing beams provides better stability when hung by ropes (similar to an arch bridge which is inverted) and is less prone to bending deformation. This characteristic allows for an increase in the width of the counterweight frame 2. For example, compared to a conventional counterweight frame, the width of the counterweight frame 2 according to the embodiment of the present invention can be 1.3 to 1.6 times that of the conventional counterweight frame. This allows for better utilization of the transverse space in the shaft, while also reducing the height of the counterweight frame 2 in the vertical direction and lowering the height of the counterweight track.

In some embodiments, the counterweight frame 2 comprises: a bottom beam 33, a top beam 34, a first longitudinal beam 31, and a second longitudinal beam 32, wherein the bottom beam 33, top beam 34, first longitudinal beam 31 and second longitudinal beam 32 are connected to form an outer contour of a rectangular frame; and a first intermediate longitudinal beam 35 and a second intermediate longitudinal beam 36 connected between the bottom beam 33 and the top beam 34. In some embodiments, the first inverted arch beam 21 and the second inverted arch beam 22 span and connect to the first longitudinal beam 31, the first intermediate longitudinal beam 35, the second intermediate longitudinal beam 36, and the second longitudinal beam 32. By connecting with four longitudinal beams, the first inverted arch beam 21 and the second inverted arch beam 22 are supported at four points, better dispersing the bearing load.

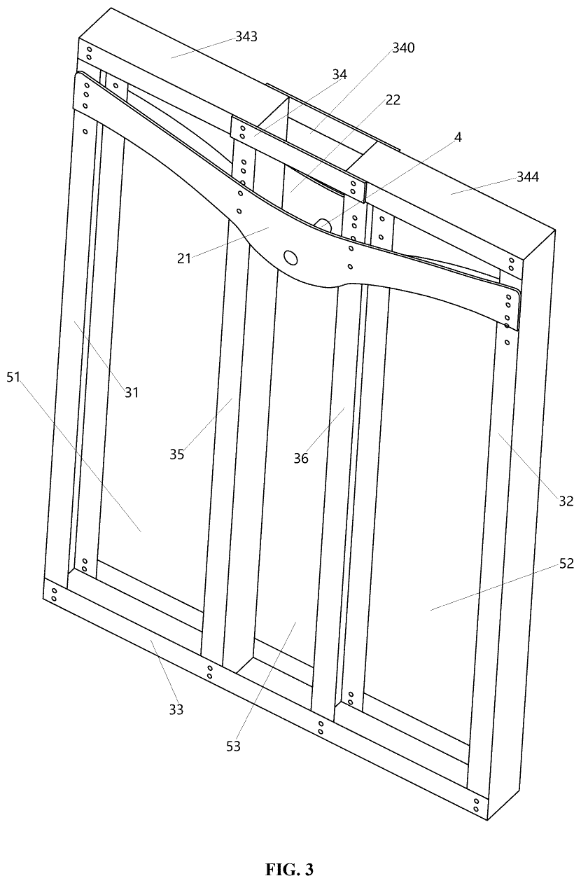

In some embodiments, a first counterweight block groove 51 is defined between the first longitudinal beam 31 and the first intermediate longitudinal beam 35, and a first set of counterweight blocks 61 are stacked in the first counterweight block groove 51 longitudinally; a second counterweight block groove 52 is defined between the second longitudinal beam 32 and the second intermediate longitudinal beam 36, and a second set of counterweight blocks 62 are stacked in the second counterweight block groove 52 longitudinally; and a third counterweight block groove 53 is defined between the first intermediate longitudinal beam 35 and the second intermediate longitudinal beam 36, and a third set of counterweight blocks 63 are stacked in the third counterweight block groove 53 longitudinally. In some embodiments, the width of the first counterweight block groove 51 and that of the second counterweight block groove 52 may be equal, while the width of the third counterweight block groove 53 is close to those of the first and second counterweight block grooves 51 and 52. For example, the width of the third counterweight block groove 53 is within +/−30% of the widths of the first and second counterweight block grooves 51 and 52, so that the weights of the respective sets of counterweight blocks are close. By arranging three parallel counterweight block grooves 51, 52, and 53, the width and weight of individual counterweight blocks can be reduced, making it easier for workers to move, lift, and mount counterweight blocks on site. In some embodiments, each of the plurality of counterweight blocks has a weight of less than 25 kilograms. In some embodiments, the bottom beam 33, the first longitudinal beam 31, the second longitudinal beam 32, the first intermediate longitudinal beam 35, and the second intermediate longitudinal beam 36 may adopt C-shaped beams, where the opening sides of the first longitudinal beam 31 and the first intermediate longitudinal beam 35 are opposite to each other to define the first counterweight block groove 51, and the opening sides of the second longitudinal beam 32 and the second intermediate longitudinal beam 36 are opposite to each other to define the second counterweight block groove 52. Alternatively, the first intermediate longitudinal beam 35 and the second intermediate longitudinal beam 36 may also adopt I-beams. The top beam 34 comprises a first batten 341 and a second batten 342, so that the first top opening and the second top opening corresponding to the first counterweight block groove 51 and the second counterweight block groove 52 are open, and the first set of counterweight blocks 61 and the second set of counterweight blocks 62 can be respectively mounted into the first counterweight block groove 51 and the second counterweight block groove 52 from the first top opening and the second top opening at the top beam 34. After the counterweight blocks are mounted in place, as shown in FIG. 3, the first top cover 343 and the second top cover 344 can be mounted on the first top opening and the second top opening at the top of the first counterweight block groove 51 and the second counterweight block groove 52, respectively. In addition, the top opening 340 corresponding to the position of the third counterweight block groove 53 of the top beam is open for the connection of the rope. Furthermore, the third set of counterweight blocks 53 can be mounted from the side into the third counterweight block groove 53 and fixed by other attachments.

In some embodiments, the first inverted arch beam 21 and the second inverted arch beam 22 may be arranged in the upper one-third area of the counterweight frame. In some embodiments, as shown in FIG. 4, the counterweight frame is bilaterally symmetrical about the vertical axis passing through the load-bearing shaft on the first and second main surfaces. In some embodiments, the first inverted arch beam 21 and the second inverted arch beam 22 have the same shape. In some embodiments, as shown in FIG. 4, the first inverted arch beam 21 and the second inverted arch beam 22 are widened in the central region. For example, the area between the first intermediate longitudinal beam 35 and the second intermediate longitudinal beam 36 has a width greater than the two end regions. In some embodiments, the upper edges 211 of the first inverted arch beam 21 and the second inverted arch beam 22 are substantially arched, while the lower edges 212 thereof have protrusions 213 that protrude from the arched contour 214 that is at an equal distance from the upper edge 211.

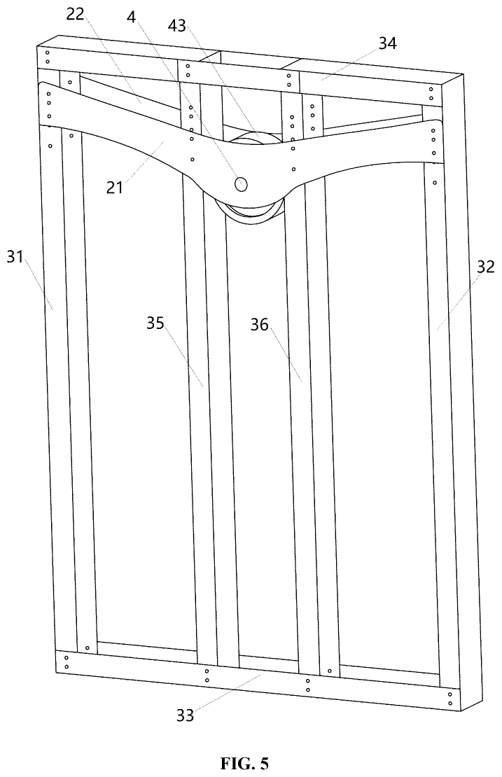

With continued reference to FIG. 5, a counterweight frame 2 according to one embodiment is shown. In the embodiment shown in FIG. 5, a pulley 43 for the traction rope is arranged on the load-bearing shaft 4, and the traction rope can wrap around the pulley 43. This structure is suitable for elevator systems with a rope winding ratio of 1:2 or 1:4. In some embodiments, the load-bearing shaft 4 can also be directly connected to rope connectors, such as locking hooks, hanging rings, etc., in order to be suitable for elevator systems with a rope winding ratio of 1:1.

With continued reference to FIG. 6, a counterweight frame 2 according to another embodiment is shown. In this embodiment, the same arrangement for counterweight frame 2 as in the previous embodiment will not be repeated. The difference is that the first inverted arch beam 21′ and the second inverted arch beam are arranged in the central area of the counterweight frame 2, such as the middle one-third area. When the first inverted arch beam 21′ and the second inverted arch beam are not arranged in the top area, such as in the lower two-thirds area, it is necessary to arrange a first additional crossbeam 37 and a second additional crossbeam above the first inverted arch beam 21′ and the second inverted arch beam to ensure overall stress stability. In addition, the first inverted arch beam 21′ and the second inverted arch beam are constructed into an inverted obtuse angle arrow shape. Taking the first inverted arch beam 21′ as an example, it includes a first straight section 211′ and a second straight section 212′. The angle between the first straight section 211′ and the second straight section 212′ is an obtuse angle, which is, for example, greater than 120 degrees. In addition, similar to the previous embodiments, the first inverted arch beam 21′ and the second inverted arch beam are widened in the central region.

With continued reference to FIG. 7, a counterweight frame 2 according to yet another embodiment is shown. In this embodiment, the same arrangement for counterweight frame 2 as in the previous embodiments will not be repeated. The difference is that the first inverted arch beam 21″ and the second inverted arch beam are arranged in the lower area of the counterweight frame 2. In this embodiment, the first additional crossbeam 37 and the first inverted arch beam 21″, and the second additional crossbeam and the second inverted arch beam are internally formed to form a frame structure. Wherein, the first inverted arch beam 21″ and the second inverted arch beam are constructed into an inverted trapezoid. Taking the first inverted arch beam 21′ as an example, it includes a first straight section 211″, a second straight section 212″, and a horizontal section 213″ between the first straight section 211″ and the second straight section 212″. The horizontal beam 214″ and the two side longitudinal beams 215″ connecting the horizontal beam 214″ and the first inverted arch beam 21″ and the second inverted arch beam on the two sides play a role in ensuring overall stress stability. The first straight section 211″ is generally between the first longitudinal beam 31 and the first intermediate longitudinal beam 35, the second straight section 212″ is generally between the second longitudinal beam 32 and the second intermediate longitudinal beam 36, and the horizontal section 213″ is generally between the first intermediate longitudinal beam 35 and the second intermediate longitudinal beam 36. The angle between the extension lines of the first straight section 211″ and the second straight section 212″ can be an obtuse angle, which is, for example, greater than 120 degrees. In addition, similar to the previous embodiments, the horizontal section 213″ is widened, that is, it has a width greater than that of the first straight section 211″ and the second straight section 212″. It should be appreciated that those skilled in the art can conceive more types of variant shapes of “inverted arch beams” based on the teachings of the present application, which may include straight sections, curved sections, and various combinations of them. These variants should be included in the meaning of “inverted arch beams”.

According to another aspect, the present invention also provides an elevator system comprising a counterweight frame 2 or a counterweight according to the various embodiments.

The counterweight frame or counterweight according to the embodiments of the present invention has an excellent mechanical structure, which can effectively widen the counterweight frame and thus has better mechanical properties compared to similar conventional frames. In the case of the same counterweight, the width of the counterweight frame is effectively reduced, the shaft space is fully utilized, and the top space is effectively reduced, which saves costs and improves the utilization rate of building space. The counterweight frame or counterweight according to the embodiments of the present invention reduces counterweight frame configuration, which is applicable to all rear counterweight elevators, including high-speed elevators.

The specific embodiments described above in the present invention are merely intended to describe the principles of the present invention more clearly, wherein various components are clearly shown or described to facilitate the understanding of the principles of the present invention. Those skilled in the art may, without departing from the scope of the present invention, make various modifications or changes to the present invention. Therefore, it should be understood that these modifications or changes should be included within the scope of patent protection of the present invention.

What is claimed is:

1. An elevator system, comprising:
an elevator car and a counterweight connected to each other through a rope;
wherein, the counterweight comprises a counterweight frame and a plurality of counterweight blocks mounted on the counterweight frame, the counterweight frame comprising:
a first main surface and a second main surface opposite to each other, wherein the counterweight blocks are arranged between the first main surface and the second main surface;
a first inverted arch beam and a second inverted arch beam connected to the first main surface and the second main surface respectively; and
a load-bearing shaft connected between the first inverted arch beam and the second inverted arch beam;
wherein, the counterweight is connected to the rope through the load-bearing shaft.

2. The elevator system according to claim 1, wherein a pulley or rope connector is provided on the load-bearing shaft.

3. The elevator system according to claim 1, wherein the first inverted arch beam and the second inverted arch beam are in the shape of an inverted curved arch, an inverted obtuse angle arrow, or an inverted trapezoid.

4. The elevator system according to claim 1, wherein the counterweight frame comprises:
a bottom beam, a top beam, a first longitudinal beam, and a second longitudinal beam, wherein the bottom beam, top beam, first longitudinal beam, and second longitudinal beam are connected to form an outer contour of a rectangular frame; and
a first intermediate longitudinal beam and a second intermediate longitudinal beam connected between the bottom beam and the top beam;
wherein, the first inverted arch beam and the second inverted arch beam span and connect to the first longitudinal beam, the first intermediate longitudinal beam, the second intermediate longitudinal beam, and the second longitudinal beam.

5. The elevator system according to claim 4, wherein a first counterweight block groove is defined between the first longitudinal beam and the first intermediate longitudinal beam, and a first set of counterweight blocks are stacked in the first counterweight block groove longitudinally;
a second counterweight block groove is defined between the second longitudinal beam and the second intermediate longitudinal beam, and a second set of counterweight blocks are stacked in the second counterweight block groove longitudinally; and
a third counterweight block groove is defined between the first intermediate longitudinal beam and the second intermediate longitudinal beam, and a third set of counterweight blocks are stacked in the third counterweight block groove longitudinally.

6. The elevator system according to claim 5, wherein a position of the top beam corresponding to the first counterweight block groove has a first top opening and a first top cover mounted on the first top opening; and a position of the top beam corresponding to the second counterweight block groove has a second top opening and a second top cover mounted on the second top opening.

7. The elevator system according to claim 1, wherein the first inverted arch beam and the second inverted arch beam are arranged in the upper one-third area of the counterweight frame.

8. The elevator system according to claim 1, wherein the first inverted arch beam and the second inverted arch beam are arranged in the lower two-thirds area of the counterweight frame, and a first additional crossbeam and a second additional crossbeam are respectively arranged above the first inverted arch beam and the second inverted arch beam.

9. The elevator system according to claim 8, wherein the first inverted arch beam is integrally formed with the first additional crossbeam, and the second inverted arch beam is integrally formed with the second additional crossbeam.

10. The elevator system according to claim 1, wherein the counterweight frame is bilaterally symmetrical on the first main surface and the second main surface, where a central area of the first inverted arch beam and the second inverted arch beam is widened.

11. The elevator system according to claim 1, wherein each of the plurality of counterweight blocks is less than 25 kilograms.

12. A counterweight for an elevator system, comprising:
a counterweight frame and a plurality of counterweight blocks mounted on the counterweight frame, the counterweight frame comprising:
a first main surface and a second main surface opposite to each other, wherein the counterweight blocks are arranged between the first main surface and the second main surface;
a first inverted arch beam and a second inverted arch beam connected to the first main surface and the second main surface respectively; and
a load-bearing shaft connected between the first inverted arch beam and the second inverted arch beam.

13. The counterweight according to claim 12, wherein a pulley or rope connector is provided on the load-bearing shaft.

14. The counterweight according to claim 12, wherein the first inverted arch beam and the second inverted arch beam are in the shape of an inverted curved arch, an inverted obtuse angle arrow, or an inverted trapezoid.

15. The counterweight according to claim 12, wherein the counterweight frame comprises:
a bottom beam, a top beam, a first longitudinal beam, and a second longitudinal beam, wherein the bottom beam, the top beam, the first longitudinal beam, and the second longitudinal beam are connected to form an outer contour of a rectangular frame; and
a first intermediate longitudinal beam and a second intermediate longitudinal beam connected between the bottom beam and the top beam;
wherein, the first inverted arch beam and the second inverted arch beam span and connect the first longitudinal beam, the first intermediate longitudinal beam, the second intermediate longitudinal beam, and the second longitudinal beam.

16. The counterweight according to claim 12, wherein a first counterweight block groove is defined between the first longitudinal beam and the first intermediate longitudinal beam, and a first set of counterweight blocks are stacked in the first counterweight block groove longitudinally;
a second counterweight block groove is defined between the second longitudinal beam and the second intermediate longitudinal beam, and a second set of counterweight blocks are stacked in the second counterweight block groove longitudinally; and
a third counterweight block groove is defined between the first intermediate longitudinal beam and the second intermediate longitudinal beam, and a third set of counterweight blocks are stacked in the third counterweight block groove longitudinally.

17. The counterweight according to claim 16, wherein a position of the top beam corresponding to the first counterweight block groove has a first top opening and a first top cover mounted on the first top opening; and a position of the top beam corresponding to the second counterweight block groove has a second top opening and a second top cover mounted on the second top opening.

18. The counterweight according to claim 12, wherein the first inverted arch beam and the second inverted arch beam are arranged in the upper one-third area of the counterweight frame.

19. The counterweight according to claim 12, wherein the first inverted arch beam and the second inverted arch beam are arranged in the lower two-thirds area of the counterweight frame, and a first additional crossbeam and a second additional crossbeam are respectively arranged above the first inverted arch beam and the second inverted arch beam.

20. The counterweight according to claim 12, wherein each of the plurality of counterweight blocks is less than 25 kilograms.
